(19) United States
(12) Patent Application Publication
(10) Pub. No.: US 2022/0316384 A1
(43) Pub. Date: Oct. 6, 2022

(54) METHOD AND DEVICE FOR MANIPULATION DETECTION ON A TECHNICAL DEVICE IN A MOTOR VEHICLE WITH THE AID OF ARTIFICIAL INTELLIGENCE METHODS

(71) Applicant: Robert Bosch GmbH, Stuttgart (DE)

(72) Inventors: Markus Hanselmann, Stuttgart (DE); Thomas Branz, Stuttgart (DE); Holger Ulmer, Ulm (DE)

(21) Appl. No.: 17/656,448

(22) Filed: Mar. 25, 2022

(30) Foreign Application Priority Data
Mar. 30, 2021 (DE) 10 2021 203 228.1

(51) Int. Cl. F01N 11/00; G05B 23/02; G07C 5/10

(52) U.S. Cl. CPC F01N 11/00; G05B 23/0254; G07C 5/10; F01N 3/035

(57) ABSTRACT

A method for manipulation detection of a technical device, i.e., an exhaust gas after treatment device in a motor vehicle, including: providing an input vector including system variable(s) and including at least one control variable for an intervention in the technical device for successive time steps; using a data-based manipulation detection model to generate a corresponding output vector as a classification vector in each time step for each input vector, each output vector indicates a classification of a monitored variable in value ranges, for the input vector; providing an actual monitored variable based on at least one measured value in the successive time steps; creating a measurement classification vector from the actual monitored variable for each time step; detecting a manipulation as a function of the measurement classification vector and a first and a second comparison vector for time step(s) of the time window.

### CROSS REFERENCE

The present application claims the benefit under 35 U.S.C. § 119 of German Patent Application No. DE 10 2021 203 228.1 filed on Mar. 30, 2021, which is expressly incorporated herein by reference in its entirety.

### FIELD

The present invention relates to motor vehicles, and in particular methods for manipulation detection of units of motor vehicles. Furthermore, the present invention relates to exhaust gas aftertreatment devices and methods for detecting a manipulation and for diagnosing exhaust gas aftertreatment devices.

### FIELD

So-called Selective Catalytic Reduction (SCR) exhaust aftertreatment systems are installed in heavy-duty trucks including diesel internal combustion engines, the task of which is to break down toxic nitrogen oxides (NOx) with the aid of a chemical reaction. For this purpose, a mixture made of water and urea has to be added to the exhaust gas (often known under the registered tradename Ad-Blue). This decomposes into ammonia by thermolysis. The reaction which converts the nitrogen oxides into water and nitrogen thereupon takes place in the catalytic converter.

The exhaust aftertreatment systems are required to meet the particular legally prescribed exhaust gas regulations. The norm Euro 6, for example, establishes the limiting value for a WHSC at 0.4 g/kWh for nitrogen oxides in trucks. For shipping companies, the proper operation of the SCR exhaust aftertreatment systems represents a not insignificant cost factor.

Technical devices in motor vehicles may be manipulated in an unauthorized manner to achieve operation which is advantageous for the driver. An exhaust gas aftertreatment device may thus be manipulated to increase the performance of the engine system or to reduce a material consumption, in particular of urea (Ad-blue).

In general, methods for detecting a manipulation are rule-based. Rule-based manipulation monitoring methods have the disadvantage that only known manipulation strategies may be recognized or known manipulations may be intercepted. Therefore, such a defense strategy is blind to novel manipulations. Moreover, it is costly to detect a complex technical system including its dependencies in a rule system and create corresponding rules for the detection of a manipulation.

For example, due to their dynamic behavior, the operating states are diverse for an exhaust gas aftertreatment device and in particular may not be unambiguously associated with the presence of a manipulation in the case of rarely occurring system states. For example, present SCR exhaust aftertreatment systems (SCR: Selective Catalytic Reduction) for denoxification (nitrogen reduction by urea injection into the exhaust gas) include legally prescribed monitoring of the system parameters relevant for error-free operation. These system parameters are monitored within the scope of an onboard diagnosis for maintaining physically reasonable limiting values and are thus checked for plausibility. For system-inherent parameters, whose values result from the combination of various control variables of the SCR regulation, it may additionally be checked whether the expected system reaction results after a system intervention. Thus, for example, upon closing of a valve, a reduction of the pressure in the hydraulic system is to be expected.

However, the use of so-called SCR emulators is noticeably occurring, which are capable of changing data in a program code of the monitoring system or sensor values which the monitoring system uses so that error detections by the monitoring system are precluded, although the SCR system is only active to a restricted extent or no longer at all. The maintenance expenditure may thus be reduced in vehicle operation and costs for refilling urea may be saved by accepting increased nitrogen oxide emission. The conventional diagnostic functions are simulated using the emulated sensor signals, which makes detecting the manipulation more difficult.

### SUMMARY

According to the present invention, a method for manipulation detection in a technical device, in particular a technical device in a motor vehicle, in particular an exhaust gas aftertreatment device, and a device and a technical system are provided.

Further embodiments of the present invention are disclosed herein.

According to a first aspect of the present invention, a method is provided for manipulation detection of a technical device, in particular a technical device in a motor vehicle, in particular an exhaust gas aftertreatment device. In accordance with an example embodiment of the present invention, the method includes the following steps:
providing an input vector including one or multiple system variables and including at least one control variable for an intervention in the technical device for successive time steps;
using a data-based manipulation detection model to generate a corresponding output vector as a classification vector in each time step for one input vector in each case, the data-based manipulation detection model being designed to output an output vector, which indicates a classification of a monitored variable in value ranges, for an input vector;
providing an actual monitored variable based on at least one measured value in the successive time steps;
creating a measurement classification vector from the actual monitored variable for each time step;
detecting a manipulation as a function of the measurement classification vector and a first and a second comparison vector for one or multiple time steps of the time window, the first and the second comparison vector being determined by rounding the element values of the output vector based on a first manipulation threshold value and a second manipulation threshold value, which is different from the first, as rounding limits.

It may be provided that the technical device includes an exhaust gas aftertreatment device, the input vector including a control variable for a urea injection system as the control variable.

According to the above example method, it is provided that a machine learning method is used to perform a manipulation detection of a technical device in a motor vehicle. With the aid of a data-based manipulation detection model, a normal behavior of the underlying technical device is learned and a deviation from its normal behavior is viewed as a consequence of a manipulation.

With the aid of deep learning methods, dependencies and properties of the technical device which are important for the underlying manipulation detection may be detected independently. Since a normal behavior of the technical device is trained in the manipulation detection model, behavior of the technical device deviating therefrom may be detected. This has the advantage that novel and previously unknown manipulation attempts may also be detected by such a manipulation detection model.

The above example method uses a manipulation detection model which is designed as a classification model. The manipulation detection model is trained to generate a classification vector as an output vector based on an input vector, which is provided in successive time steps. The elements of the input vector each correspond to the values of system variables and at least one control variable in a time step and reflect an instantaneous state of the system. The classification vector indicates in which value range a value of a monitored variable is located, as a function of the input vectors of a time step.

By forming the manipulation detection model as an at least partially recurrent network, the manipulation detection model may also take into consideration dynamic effects of the technical device.

Furthermore, the output vector may include nominal coding which indicates for the monitored variable in which value ranges the monitored variable lies, the value ranges being classified by a number of classes, the value ranges of the monitored variable each being indicated with ascending index values k of the output vector by corresponding ascending/descending (ordered) classification threshold values S₁, S₂, S₃, . . . , S_{K-1}, the element values of the output vector indicating with their value whether the monitored variable is expected to be less or greater than the classification threshold value corresponding to the index value of the element of the output vector.

The evaluation of the classification vector to indicate the approximate monitored variable thus includes a coding scheme, as disclosed, for example, in the publication by J. Cheng et al., “A Neural Network Approach to Ordinal Regression,” IEEE International Joint Conference on Neural Networks, pages 1279 to 1284, 2008. In this case, each class is represented by a K-dimensional vector, K classes including ascending index values k each indicating for correspondingly ascending/descending classification threshold values S₁, S₂, S₃, . . . , S_{K-1} whether monitored variable y is expected to be less or greater or greater or less than corresponding classification threshold value S₁, S₂, S₃, . . . , S_{K}, i.e., (1, 0, . . . 0) for y<S₁, (1, 1, 0, . . . 0) for y<S₂, (1, 1, 1, 0, . . . 0) for y<S₃ etc. up to (1, . . . , 1) for y>=S_{K-1}. A classification vector including (1, 1, . . . , 1, 0, . . . , 0) coding results therefrom. In particular, the first class is represented by a K-dimensional vector (1, 0, . . . , 0) and the Kth class accordingly by a K-dimensional 1 vector (1, . . . , 1). This coding is also referred to as nominal coding for nominal classes.

The manipulation detection model may correspond to a neural network for outputting an output vector including K elements, i.e., for example, with the aid of a fully connected layer including K neurons, the output layer including a monotonously increasing activation function, for example, a sigmoid activation function, which includes a value range from 0 to 1.

In accordance with an example embodiment of the present invention, to evaluate the manipulation detection model, for each time step the present input variables, i.e., the system variables and the at least one control variable, are supplied in the form of the corresponding input vector to the manipulation detection model and a corresponding output vector is obtained as the classification vector. Since the elements of the output vector may assume values between 0 and 1, these indicate a modeling probability that the monitored variable will be located within the value range of the monitored variable defined by index value k or is possibly greater. For example, an output (0.99, 0.9, 0.8, 0, . . . , 0) may be interpreted to mean that the true value is located with 99% probability at least in the value range of class 1, the true value is located with 90% probability at least in the value range of class 2, etc. Whether the true value is even greater with a certain probability may be recognized in that one observes the probabilities for the following classes 3, 4, . . . . The classification of the manipulation detection model may be evaluated using a method described hereinafter in successive time windows each including one or multiple time steps.

In accordance with an example embodiment of the present invention, for each time window, the one or the multiple input vectors of the associated successive time steps are classified in accordance with the class categorization provided for the manipulation detection model and a corresponding output vector is obtained for each time step.

Furthermore, for each time step the actual monitored variable is measured in the technical device or ascertained from measured values.

In accordance with an example embodiment of the present invention, it may be provided that the measurement classification vector including a nominal coding is created using the value of the actual monitored variable.

The actual monitored variable is converted in accordance with the class categorization provided for the training of the manipulation detection model into a measurement classification vector. This is carried out using the above-described nominal coding, K classes including ascending index values k for particular corresponding ascending/descending classification threshold values S₁, S₂, S₃, . . . , S_{K-1} indicating whether actual monitored variable yᵣₑₐₗ is less or greater or greater or less than corresponding classification threshold value S₁, S₂, S₃, . . . , S_{K}.

It may be provided that the elements of the measurement classification vector have a first value if the actual monitored variable is expected to be less or greater than the classification threshold value corresponding to the index value of the element of the output vector and have a second value if the actual monitored variable is expected to be greater or less than the classification threshold value corresponding to the index value of the element of the output vector.

Furthermore, to determine the first comparison vector, the elements of the output vector may be rounded to a first value based on exceeding the first manipulation threshold value as a rounding limit and to a second value based on not reaching the first manipulation threshold value as a rounding limit, to determine the second comparison vector, the elements of the output vector being rounded to the first value based on exceeding the second manipulation threshold value as a rounding limit and being rounded to the second value based on not reaching the second manipulation threshold value as a rounding limit, the manipulation being recognized as a function of a difference between the number of the element values of the first comparison vector having the first value and the number of the element values of the measurement classification vector having the first value and as a function of a difference between the number of the element values of the measurement classification vector having the first value and the number of the element values of the second comparison vector having the first value.

For example, a first comparison vector is ascertained from the particular output vector, in which all elements in the output vector which are greater than a predefined first manipulation threshold value of, for example, 0.75, are assigned a 1, and all elements having a lower value than the first manipulation threshold value are assigned an element value of 0. The first comparison vector may be compared to the measured value classification vector. A first manipulation value results from the difference of the number of the elements of the measurement classification vector having the element value of “1” (exemplary first value) and the number of elements of the first comparison vector having the element value of “1” (exemplary first value). For multiple time steps, the differences may be summed or aggregated in another way to obtain the first manipulation value.

For example, a second comparison vector is ascertained from the particular output vector, in which all elements in the output vector which are greater than a predefined second threshold value of, for example, 0.05, are assigned a 1, and all elements having a lesser value than the first manipulation threshold value are assigned an element value of “0” (exemplary second value). The second manipulation threshold value is selected to be significantly less than the first threshold value. The second comparison vector may be compared to the measured value classification vector. A second manipulation value results from the difference of the number of the elements of the second comparison vector having the element value of “1” (exemplary first value) and the number of elements of the measurement classification vector having the element value of “1.” For multiple time steps, the differences may be summed or aggregated in another way to obtain the second manipulation value.

A manipulation detection value may be ascertained as a function of the first and the second manipulation value. The method may be carried out separately for each time window or also for multiple time windows of an evaluation time window.

For each time window, a manipulation signal may be generated, a manipulation being recognized as a function of the portion of the manipulation signals indicating a manipulation for multiple time windows of an evaluation time period.

It may be provided that the technical device includes an exhaust gas aftertreatment device, the input vector including a control variable for a urea injection system as the control variable. In particular, a recognized manipulation may be signaled or the technical device may be operated as a function of the recognized manipulation.

According to a further aspect of the present invention, a device is provided for manipulation detection of a technical device, in particular a technical device in a motor vehicle, in particular an exhaust gas aftertreatment device. In accordance with an example embodiment of the present invention, the device is designed to:
provide an input vector including one or multiple system variables and including at least one control variable for an intervention in the technical device at successive time steps;
use a data-based manipulation detection model to generate a corresponding output vector as a classification vector in each time step for one input vector in each case, the data-based manipulation detection model being designed to output an output vector, which indicates a classification of a monitored variable in value ranges, for an input vector;
provide an actual monitored variable based on at least one measured value in the successive time steps;
create a measurement classification vector from the actual monitored variable for each time step;
recognize a manipulation as a function of the measurement classification vector and a first and a second comparison vector for one or multiple time steps of the time window, the first and the second comparison vectors being determined by rounding the element values of the output vector based on a first manipulation threshold value and a second threshold manipulation value, which is different from the first, as rounding limits.

### BRIEF DESCRIPTION OF THE DRAWINGS

Specific embodiments are explained hereinafter in greater detail on the basis of the figures.

### Brief Description of the Drawings

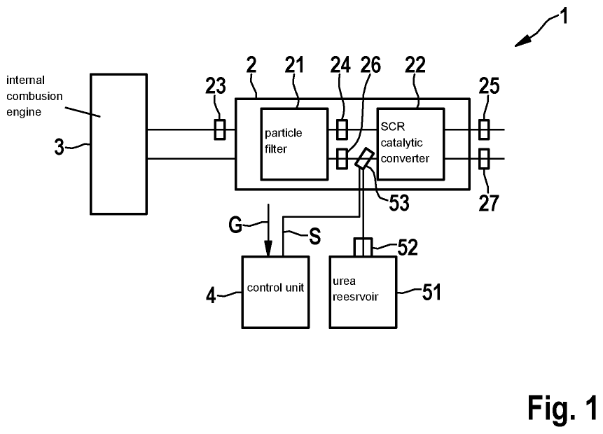

FIG. 1 shows a schematic representation of an exhaust gas aftertreatment device as an example of a technical system.

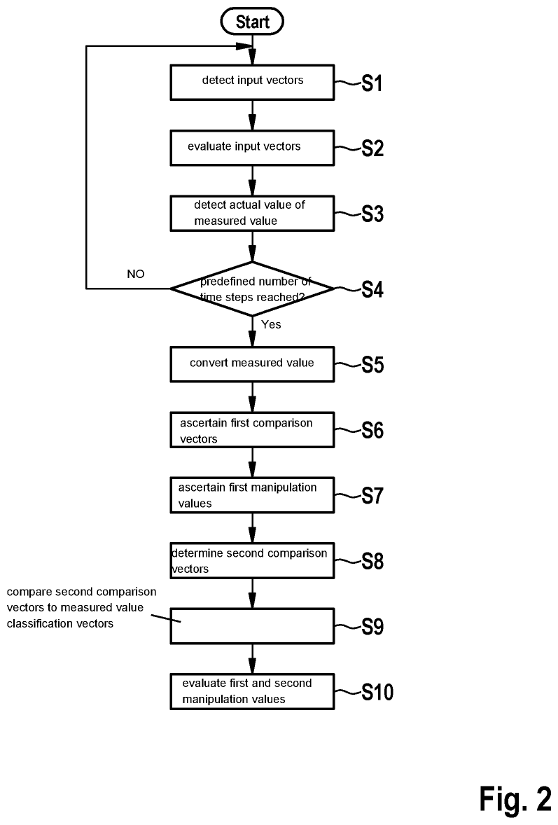

FIG. 2 shows a flow chart to illustrate a method for manipulation detection of the exhaust gas aftertreatment device of FIG. 1, in accordance with an example embodiment of the present invention.

### DETAILED DESCRIPTION OF EXAMPLE EMBODIMENTS

FIG. 1 shows a schematic representation of an exhaust aftertreatment system 2 for an engine system 1 including an internal combustion engine 3. Exhaust gas aftertreatment device 2 is designed for exhaust aftertreatment of combustion exhaust gases of internal combustion engine 3. Internal combustion engine 3 may be designed as a diesel engine.

Exhaust gas aftertreatment device 2 includes a particle filter 21 and an SCR catalytic converter 22. The exhaust gas temperature is measured using a particular temperature sensor 23, 24, 25 upstream from particle filter 21, downstream from particle filter 21, and upstream from SCR catalytic converter 22 and the NOₓ content is measured using a particular NOx sensor 26, 27 upstream and downstream from SCR catalytic converter 22 and processed in a control unit 4. The sensor signals are provided as system variables G to the control unit.

A urea reservoir 51, a urea pump 52, and a controllable injection system 53 are provided for the urea. Injection system 53 enables, controlled by control unit 4 with the aid of a control variable S, urea to be supplied in a predetermined quantity into the combustion exhaust gas upstream from SCR catalytic converter 22.

Control unit 4 controls according to conventional methods the supply of urea upstream from SCR catalytic converter 22 by specifying a control variable for injection system 53, to achieve the best possible catalyzation of the combustion exhaust gas, so that the nitrogen oxide content is reduced as much as possible.

Conventional manipulation devices manipulate sensor signals and/or control signals to reduce or completely stop the consumption of urea.

Such manipulations may be recognized by rule-based monitoring of operating states of the exhaust gas aftertreatment device, however, all corresponding unauthorized operating states may not be checked in this way. Therefore, a manipulation detection method based on a manipulation detection model is provided. This may be carried out in control unit 4, as shown by way of example on the basis of the flowchart of FIG. 2. The method may be implemented in control unit 4 as software and/or hardware.

In step S1, input vectors made up of system variables G and the at least one control variable S, in particular the control variable for injection system 53 for the urea, are detected for one or multiple time steps.

System variables S may include one or multiple of the following variables: the above exhaust gas temperatures, the above NOx concentrations, an instantaneous engine torque, an instantaneous air charge of internal combustion engine 3, a number of revolutions of internal combustion engine 3, an injected fuel quantity of internal combustion engine 3, a pressure in the exhaust gas system, an NH3 concentration, an oxygen concentration in the combustion exhaust gas, a DeNOX efficiency (DeNOx is ascertained on the basis of the NOx concentrations before and after the SCR catalytic converter), an engine temperature, a driver-desired torque, for example, as specified by an accelerator pedal position, a vehicle velocity, an ambient pressure, an ambient temperature, a selected gear of the gearshift, a vehicle weight, a position of an exhaust gas recirculation valve, and a soot quantity in the combustion exhaust gas.

In step S2, the input vectors are evaluated with the aid of a pre-trained data-based manipulation detection model to obtain an output vector for each time step.

The manipulation detection model is designed to output a classification vector as an output vector as a function of an input vector in each time step. The data-based manipulation detection model includes a suitable structure for modeling the dynamic behavior of the technical device, which permits modeling of a dynamic behavior. For example, the data-based manipulation detection model may include a neural network including recurrent components, for example, a combination of “fully connected” layers and recurrent layers, as is available, for example, in LSTM or GRU models. Alternatively, data-based models such as NARX Gaussian process models may also be provided to map the dynamic behavior of the technical device.

The manipulation detection model is designed to output the output vector in a format of a nominal coding for nominal classes. This format provides indicating each class with a K-dimensional vector, K classes including ascending index values k being defined for each of corresponding ascending/descending classification threshold values S₁, S₂, S₃, . . . , S_{K-1} as to whether monitored variable y is expected to be less or greater or greater or less than corresponding classification threshold value S₁, S₂, S₃, . . . , S_{K}, i.e., (1, 0, . . . 0) for y<S₁, (1, 1, 0, . . . 0) for y<S₂, (1, 1, 1, 0, . . . 0) for y<S₃ etc., up to (1, . . . , 1) for y>=S_{K-1}. A classification vector including (1, 1, . . . , 1, 0, . . . , 0) coding results therefrom. In particular, the first class is represented by a K-dimensional vector (1, 0, . . . , 0) and the Kth class is accordingly represented by a K-dimensional 1 vector (1, . . . , 1).

The training of the manipulation detection model may take place over multiple epochs in a conventional way. In each epoch all training data are processed. The training data correspond to the input vectors of system variables and the at least one control variable, which were recorded in a manipulation-secure operating environment of exhaust gas aftertreatment device 2. A corresponding measured value of the monitored variable, i.e., the exhaust-side nitrogen oxide concentration, is associated with the input vector. Prior to the training, this measured value is classified in accordance with a class categorization, which are defined by classification threshold value S₁, S₂, S₃, . . . , S_{K}. Therefore, with ascending or descending classification threshold values S₁, S₂, S₃, . . . , S_{K}, an association of each of the measured values with a classification vector results. This classification vector is now used as a label for the training of the manipulation detection model.

Furthermore, the training data are divided into batches, whose batch size is freely predefinable, but typically a power of two is selected to achieve optimum parallelization ability. Moreover, the length of the evaluation time periods is predefined. Preferably, 500 to 3000 training data, which each correspond to one measured time step, are suitable.

The input values may be preprocessed for the training if needed. It is thus typical, for example, to norm them, norm them robustly, or standardize them. The mean squared error or the root mean squared error or binary cross entropy may be used as an error function for training the manipulation detection model. The calculated errors are used in a conventional manner to adapt the weights of the neural network with the aid of back-propagation and a typical optimization strategy, e.g., SGD, Adam, Adagrad, and the like.

The evaluation of the manipulation detection model results in the output of an output vector, whose elements may assume values in the value range between 0 and 1, in accordance with the norming of the measured value during the training method in a classification vector. Other codings for the value range are also possible in a similar manner. In the described exemplary embodiment, the output vector has the value between 0 and 1 for each element, which indicates a probability that the monitored variable, i.e., the downstream nitrogen oxide concentration, is in the value range indicated by the index value of the element. Thus, for example, an element value of 0 indicates a zero probability that the value of the monitored variable is within the value range predefined by the index value. On the other hand, an element value of 1 indicates an absolute certainty of the manipulation detection model that the value of the monitored variable is within the value range predefined by the index value. An output vector, whose element values drop with ascending index value, is typically output in the case of the coding used above.

The output vector is stored for each or the present time step.

At the same time, in a following step S3, an actual value of the monitored variable, for example, the measured value of the exhaust-side nitrogen oxide concentration, is detected and stored for the particular time step.

If it is established in step S4 that a predefined number of the time steps is reached for the time window to be observed (alternative: yes), the method is thus continued with step S5, otherwise (alternative: no), the sequence jumps back to step S1. The predefined number of the time steps for the time window may be 1 or more than 1. In particular, the number of time steps may be between 50 and 500.

In the following steps, the evaluation is carried out of the stored output vectors and the corresponding measured value of the actual monitored variable for one or multiple time steps of the time window. For this purpose, in step S5, initially the measured value is converted in accordance with the class categorization, which is also from the training of the manipulation detection model, into a measured value classification vector. This takes place according to the above scheme in accordance with the predefined classification range threshold values, which each indicate ranges to obtain a measured value classification vector in accordance with a nominal coding.

Subsequently, in step S6, for each time step a first comparison vector is accordingly ascertained as a function of a first manipulation threshold value. The first manipulation threshold value specifies for the output vector a rounding scheme, in which all values greater than the first manipulation threshold value are rounded to 1 (first value) and all values less than the first manipulation threshold value are rounded to 0 (second value). A first comparison vector is now obtained for each time step in the evaluation time period. Like the measured value classification vector, this only includes elements having the element values of 0 and 1.

In step S7, for each time step a first manipulation value is now ascertained as a difference between the element sum of the measured value classification vector and the element sum of the first comparison vector and possibly summed or aggregated over the time steps. A quotient may also be determined from the sum of the element sums of the measured value classification vector for multiple time steps of the time window and the sum of the element sums of the first comparison vector for multiple time steps of the time window as a first manipulation value.

In particular, it is checked in this first comparison which portion of the values in which the manipulation detection model is very secure corresponds to the actual measurement results. In the normal mode, it is to be expected that only a very small portion of “1” values (first values) of the first comparison vector will be outside the measurement comparison vector.

If the present value of the monitored variable is, for example, higher than usual for a certain time period for technical reasons, in the best case the model indicates this, there is correspondence with the measured value. However, in the event of an attempted manipulation, it is not previously known that the value of the monitored variable will be higher than usual in this range—the manipulated sensor value accordingly does not ascend, there is a deviation from the value of the monitored variable.

Subsequently, in step S8, a second comparison vector is determined with the aid of a second manipulation threshold value from the output vector. The second manipulation threshold value predefines, as described above, a rounding scheme, i.e., all values greater than the second manipulation threshold value are rounded to 1 (first value), all values less than the second manipulation threshold value are rounded to the value 0 (second value). The second manipulation threshold value is preferably significantly less than the first manipulation threshold value and may be predefined, for example, having a value between 0.05 and 0.2.

In step S8 it is so to speak checked in reverse whether the measured value is in a value range in which the manipulation detection model is secure for a predefined probability. For example, if only the first comparison were carried out, a manipulation attempt could simply predefine a constant high value of the monitored variable by a corresponding intervention, without a manipulation being recognized by the first comparison.

In step S9, the second comparison vector may be compared to the measured value classification vector. A second manipulation value results from the difference of the number of the elements of the second comparison vector having the element value of “1” or the element sum and the number of elements of the measurement classification vector having the element value of “1” or its element sum. For the time steps of the time window, the differences may be summed or aggregated in another way to obtain the second manipulation value. A quotient may also be determined from the sum of the element sums of the second comparison vector for multiple time steps of the time window and the sum of the element sums of the measured value classification vector for multiple time steps of the time window as a second manipulation value.

In a subsequent step S10, the first and second manipulation values are evaluated to establish a manipulation for the present time window. The first and second manipulation value may each be compared to a predefined threshold value to generate a manipulation signal for the present time window which indicates whether a manipulation possibly exists or not. For example, a manipulation signal for the present time window may indicate that a manipulation exists if one of the first and second manipulation values already exceeds a predetermined threshold value, and thus is recognized as an anomaly. A manipulation signal for the present time window may also indicate that a manipulation exists if a mean value, which is weighted in particular, of the first and second manipulation values exceeds a predetermined threshold value, and thus an anomaly is recognized.

Manipulation signals may thus be ascertained for each of the time windows, a manipulation being recognized if at least a predefined portion of the manipulation signals of multiple time windows indicates the presence of a manipulation.

What is claimed is:

1. A method for manipulation detection of a technical device, the method comprising the following steps:
providing an input vector including one or multiple system variables and including at least one control variable for an intervention in the technical device, for successive time steps;
using a data-based manipulation detection model to generate a corresponding output vector as a classification vector in each time step for each input vector, the data-based manipulation detection model being configured to output an output vector, which indicates a classification of a monitored variable in value ranges, for the input vector;
providing an actual monitored variable based on at least one measured value in the successive time steps;
creating a measurement classification vector from the actual monitored variable for each time step; and
detecting a manipulation as a function of the measurement classification vector and a first and a second comparison vector for one or multiple of the time steps of a time window, the first and the second comparison vector being determined by rounding element values of the output vector based on a first manipulation threshold value and a second manipulation threshold value, which is different from the first manipulation threshold value, as rounding limits.

2. The method as recited in claim 1, wherein the technical device is an exhaust gas aftertreatment device in a motor vehicle.

3. The method as recited in claim 1, wherein the output vector includes a nominal coding which indicates for the monitored variable in which value ranges the monitored variable lies, the value ranges being classified by a number of classes, the value ranges of the monitored variable including ascending index values k of the output vector each being indicated by corresponding ascending/descending classification threshold values S₁, S₂, S₃, . . . , S_{K-1}, the threshold values indicating with their value whether the monitored variable is expected to be less or greater than the classification threshold value corresponding to the index value of the element of the output vector.

4. The method as recited in claim 3, wherein the measurement classification vector including a nominal coding is created using the value of the actual monitored variable, the elements of the measurement classification vector having a first value when the actual monitored variable is expected to be less or greater than the classification threshold value corresponding to the index value of the element of the output vector and having a second value when the actual monitored variable is expected to be greater or less than the classification threshold value corresponding to the index value of the element of the output vector.

5. The method as recited in claim 4, wherein to determine the first comparison vector, the elements of the output vector are rounded to the first value based on exceeding the first manipulation threshold value as a rounding limit and to a second value based on not reaching the first manipulation threshold value as a rounding limit, to determine the second comparison vector, the elements of the output vector being rounded to the first value based on exceeding the second manipulation threshold value as a rounding limit and being rounded to the second value based on not reaching the second manipulation threshold value as a rounding limit, the manipulation being recognized as a function of a difference between the number of the element values of the first comparison vector having the first value and the number of the element values of the measurement classification vector having the first value and as a function of a difference between the number of the element values of the measurement classification vector having the first value and the number of the element values of the second comparison vector having the first value.

6. The method as recited in claim 1, wherein for each time window, a manipulation signal is generated, a manipulation being recognized as a function of a portion of the manipulation signals indicating a manipulation for multiple time windows of an evaluation time period.

7. The method as recited in claim 1, wherein the technical device includes an exhaust gas aftertreatment device, the input vector including as the control variable a control variable for a urea injection system.

8. The method as recited in claim 1, wherein a recognized manipulation is signaled or the technical device is operated as a function of the recognized manipulation.

9. A device for manipulation detection of a technical device, the device being configured to:
provide an input vector including one or multiple system variables and including at least one control variable for an intervention in the technical device, for successive time steps;
use a data-based manipulation detection model to generate a corresponding output vector as a classification vector in each time step for each input vector, the data-based manipulation detection model being configured to output an output vector, which indicates a classification of a monitored variable in value ranges, for the input vector;
provide an actual monitored variable based on at least one measured value in the successive time steps;
create a measurement classification vector from the actual monitored variable for each time step;
recognize a manipulation as a function of the measurement classification vector and a first and a second comparison vector for one or multiple of the time steps of a time window, the first and the second comparison vector being determined by rounding element values of the output vector based on a first manipulation threshold value and a second manipulation threshold value, which is different from the first, as rounding limits.

10. The device as recited in claim 9, wherein the technical device is an exhaust gas aftertreatment device in a motor vehicle.

11. A non-transitory machine-readable memory medium on which is stored a computer program for manipulation detection of a technical device, the computer program, when executed by a computer, causing the computer to perform the following steps:
providing an input vector including one or multiple system variables and including at least one control variable for an intervention in the technical device, for successive time steps;
using a data-based manipulation detection model to generate a corresponding output vector as a classification vector in each time step for each input vector, the data-based manipulation detection model being configured to output an output vector, which indicates a classification of a monitored variable in value ranges, for the input vector;
providing an actual monitored variable based on at least one measured value in the successive time steps;
creating a measurement classification vector from the actual monitored variable for each time step; and
detecting a manipulation as a function of the measurement classification vector and a first and a second comparison vector for one or multiple of the time steps of a time window, the first and the second comparison vector being determined by rounding element values of the output vector based on a first manipulation threshold value and a second manipulation threshold value, which is different from the first manipulation threshold value, as rounding limits.
